(19) United States
(12) Patent Application Publication
(10) Pub. No.: US 2007/0038926 A1
(43) Pub. Date: Feb. 15, 2007

(54) Method for automatically embedding TabIndex attributes

(76) Inventors: Naohiro Harima, Yokohama City (JP); Masaya Higuchi, Yamato (JP)

Correspondence Address: LIEBERMAN & BRANDSDORFER, LLC, 802 STILL CREEK LANE, GAITHERSBURG, MD, 20878, US

(21) Appl. No.: 11/199,777

(22) Filed: Aug. 9, 2005

(51) Int. Cl. G06F 17/21; G06F 15/00

(52) U.S. Cl. 715/513

(57) ABSTRACT

A method and apparatus are provided for specifying rules for embedding TabIndex attributes into an HTML formatted document, and for automatically formatting the document with the specified TabIndex attributes. The developer specifies the rules based upon specified parameters, including but not limited to priority of assignment of identified tags, and assignment of priority based upon horizontal and vertical positions. Following selection of rules, the TabIndex attributes are automatically embedding into the selected tags.

### BACKGROUND OF THE INVENTION

1. Technical Field

This invention relates to a method of automatically embedding a TabIndex element within a hyper text markup language (“HTML”) page. More specifically, this invention relates to automatic assignment of TabIndex attributes within a HTML formatted document.

2. Description Of The Prior Art

It is well known in the computer field to couple a plurality of computer systems into a network of computer systems. By creating a network of computer systems, collective resources available within the network may be shared among users of the network. With the growth of computerized distributed information resources, such as the Internet and private Intranets, sharing of computer resources is now commonly available. Both the Internet and Intranets have become a source for sharing information on medium and larger scale systems and allow users to retrieve vast amounts of electronic information previously unavailable in an electronic medium.

Networked systems utilizing hypertext conventions typically follow a client-server architecture. A client is usually a computer that requests a service provided by another computer known as a server. The server is typically a remote computer system accessible over a communications medium. Based upon requests by the user at the client, the server presents information to the user as responses to the client requests. The client typically contains a program called a browser that communicates the requests to the server and formats the responses for viewing at the client. The server scans and searches for unprocessed information sources based upon requests by the user. The server presents filtered electronic information to the user as server responses to the client. The client may be active in a first computer system and the server process may be active in a second computer system. This allows the client and server to communicate with one another over a communications medium thereby allowing multiple clients to take advantage of the information-gathering capabilities of the server. Accordingly, a server is a network computer that executes administrative software that controls access to all or part of the network and its resources, and makes resources available to remote users on the network.

One common use of the Internet and private Intranets is providing access to files within the system. A standard page description language known as the Hypertext Markup Language (HTML) provides basic document formatting and allows the developer to specify links to servers and specific files stored on the servers and their associated media. Retrieval of information is generally achieved through the use of a browser at a client machine configured to display HTML formatted files. HTML formatted documents commonly function as forms with input fields to receive data from people completing the forms. A person accessing the form through a browser can move to the field through use of a mouse, trackball, and a tab key on the keyboard. The order of movement among the fields using the tab key can be specified in a TabIndex attribute defined in an HTML formatted document. The tabbing order defines the order in which elements will receive focus when navigated by the user via the keyboard. Developers of the input forms are encourage to embed TabIndex attributes when creating the forms as a means of managing the data input process for people completing the forms. However, this does not always happen since embedding TabIndex attributes it is a manual process.

Conventional methods for embedding TabIndex attributes in an HTML formatted document require developers to consciously embed the TabIndex attributes for each text box. However, there are many cases in which TabIndex attributes are not embedded with the text box by the developer of the form. For example, the TabIndex attributes may not be embedded because it is a step that is commonly omitted by the developer since it is not considered an essential function of the HTML formatted document and requires additional time and effort, thereby increasing costs to the developer.

There are known methods for embedding TabIndex attributes in an html formatted document. As noted above, the TabIndex attributes may be manually set by a developer. Although it is known in the art to use a TabIndex attribute within an HTML formatted document, to date, a TabIndex attribute is manually embedded into the document by the developer when formatting the TabIndex of HTML content. Because doing so becomes increasingly difficult as the number of fields increases, programmers often bypass this function. Accordingly, given the demand for HTML page creation with increased efficiency and navigational ease, there is a need for an automation tool to efficiently embed TabIndex attributes into appropriate fields of an HTML document.

### SUMMARY OF THE INVENTION

This invention comprises a method and apparatus for automating assignment of TabIndex attributes in an HTML formatted document.

In one aspect of the invention, a method is provided for formatting HTML content. Rules are provided for adding TabIndex attributes to a tag in a HTML formatted document. The TabIndex attributes are automatically added into the document in response to the provided rules.

In another aspect of the invention, a tool is provided for formatting a HTML document. The tool includes a rule manager to direct a set of rules to specify addition of TabIndex attributes to a tag in a HTML formatted document. In addition, the tool includes a TabIndex manager to automatically add the TabIndex attributes into the document in response to the rules.

In yet another aspect of the invention, a computer program product is provided with a computer useable medium embodying computer usable program code for formatting HTML content. The computer program product includes computer useable program code for specifying rules for adding TabIndex attributes to a tag in a HTML formatted document. In addition, the computer product includes computer useable program code for automatically adding the TabIndex attributes into the document responsive to the rules.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a block diagram of an attribute assignment tool according to the preferred embodiment of this invention, and is suggested for printing on the first page of the issued patent.

FIG. 2 is a flow chart illustrating automated assignment of TabIndex attributes.

FIG. 3 is a block diagram of an exemplary list of programmable elements for selection for inclusion in the assignment.

FIG. 4 is a block diagram of an exemplary list of programmable elements for hierarchical selection for assignment.

### DESCRIPTION OF THE PREFERRED EMBODIMENT

### Overview

A method and apparatus are provided to automatically assign TabIndex attributes to select text boxes in an HTML formatted document. The tool enables the developer to set specific rules and associated parameters for assignment of the attributes. For example, the developer may select from a list of text box categories, the developer may set a hierarchical ordering for selected categories of text boxes, the developer may select the position arrangement of the text boxes. Following selection of the rules which the developer may invoke, the document is automatically formatted to ensure that the assignment of the TabIndex attributes coincide with the selected rules.

### Technical Details

An HTML form is a section of a document containing normal content, markup, special elements called controls (checkboxes, radio buttons, menus, etc.), and labels on those controls. Users generally “complete” a form by modifying its controls (entering text, selecting menu items, etc.), before submitting the form to an agent for processing (e.g., to a HTML server, a mail server, etc.). Each control that includes a field for receiving indicia is referred to hereinafter as text box. As a person scrolls through an input form, the text box is configured to receive indicia within set programming rules. Each text box may have a tag associated therewith, wherein the tag is a command inserted in a document that specifies how the document, or a portion of the document, should be formatted. Tags are used by all format specifications that store documents as text files. Each tag may have an assigned characteristic associated therewith, also known as an attribute. HTML defines the structure and layout of a HTML document by using a variety of tags and attributes.

HTML formatted documents commonly include forms with fields indexed to be accessed through use of the tab key and to receive data from people completing the forms. Each field that can be accessed through the tab key is also known as having a TabIndex attribute. A person accessing the form through a HTML browser can move to each of these fields through use of a mouse, trackball, and a tab key on the keyboard. The order of movement among the fields using the tab key can be specified in an associated attribute of the field, also known as a TabIndex attribute, as defined in an HTML document. The tabbing order defines the order in which elements will receive focus when navigated by the user via the keyboard. Developers of the input forms are encourage to embed TabIndex attributes into the fields of the text boxes when creating the forms. However, this does not always happen since it is a manual and time consuming process.

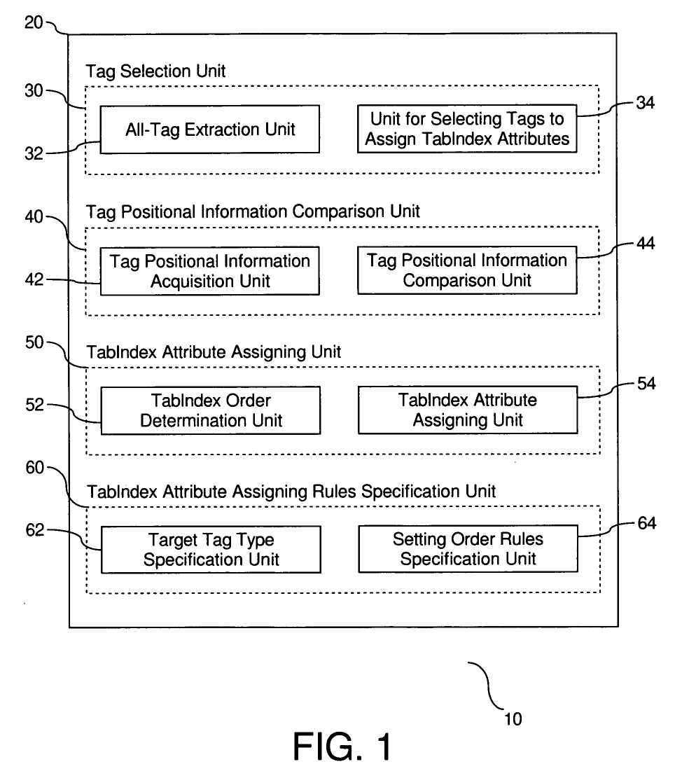

FIG. 1 is a block diagram (10) illustrating the elements in the attribute assignment tool (20). As shown, there are four primary elements to the tool. There is a tag selection unit (30), a tag positional information comparison unit (40), a TabIndex attribute assigning unit (50), and a TabIndex attribute assigning rule specification unit (60). The tag selection unit (30) has an all tag extraction unit (32) and a unit for selecting tags to assign TabIndex attributes (34). The all tag extraction unit (32) searches an HTML formatted document to obtain all tags on the document. The unit for selecting tags to assign TabIndex attributes (34) identifies and selects a group of tags that have been chosen for assignment of a TabIndex attribute based upon select characteristics of the tags. The tag positional information unit (40) has a tag positional information acquisition unit (42) and a tag positional information comparison unit (44). The tag position information acquisition unit (42) obtains and stores information associated with the position for select classification of tags. The tag positional information comparison unit (44) performs a comparison of the position of the text box within the document with the position information stored in the tag positional information acquisition unit (42). The TabIndex attribute assigning unit (50) has a TabIndex order determination unit (52) and a TabIndex attribute assigning unit (54). The TabIndex order determination unit (52) acquires and stores data associated with a specified order for assignment of TabIndex attributes to select tags and embeds the TabIndex attribute into the HTML document. The TabIndex attribute assigning unit (54) assigns the attributes to the select tags. The TabIndex attribute assigning rules specification unit (60) has a target tag type specification unit (62) and a setting order rules specification unit (64). The target tag type specification unit (62) provides a list of tags from which a developer may select for automatic assignment of TabIndex attributes. The setting order rules specification unit (64) enables a developer to prioritize assignment of TabIndex attributes based upon the list of tag types available for assignment. Accordingly, the four primary units shown herein function in association with a set of rules to automatically assign TabIndex attributes to select tags in an HTML formatted document.

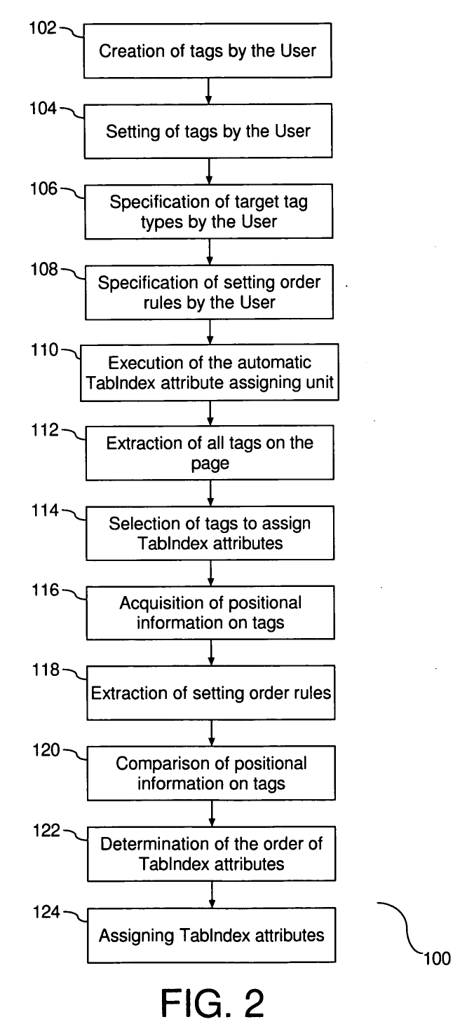

FIG. 2 is a flow chart (100) demonstrating the process for embedding TabIndex attributes to select tags in a HTML formatted document. Initially, the developer of the HTML document creates tags during the development stage of the document (102), followed by the developer setting the tags to select text boxes (104). Thereafter, the developer or person utilizing the tool, specifies the types of tags within the document that they want to automatically assign TabIndex attributes (106) in association with the unit for selecting tags to assign TabIndex attributes (32). The tool enables the developer to select from the following list of elements for which Tablndex attributes may be automatically assigned: <a>, <button>, <div>, <img>, <input>, <select>, and <textarea>. The developer may also specify the order rules for assignment of TabIndex attributes (108) in conjunction with the TabIndex order determination unit (52). Accordingly, the first part of the process for embedding TabIndex attributes is creating tags and selecting elements to which TabIndex attributes are to be assigned.

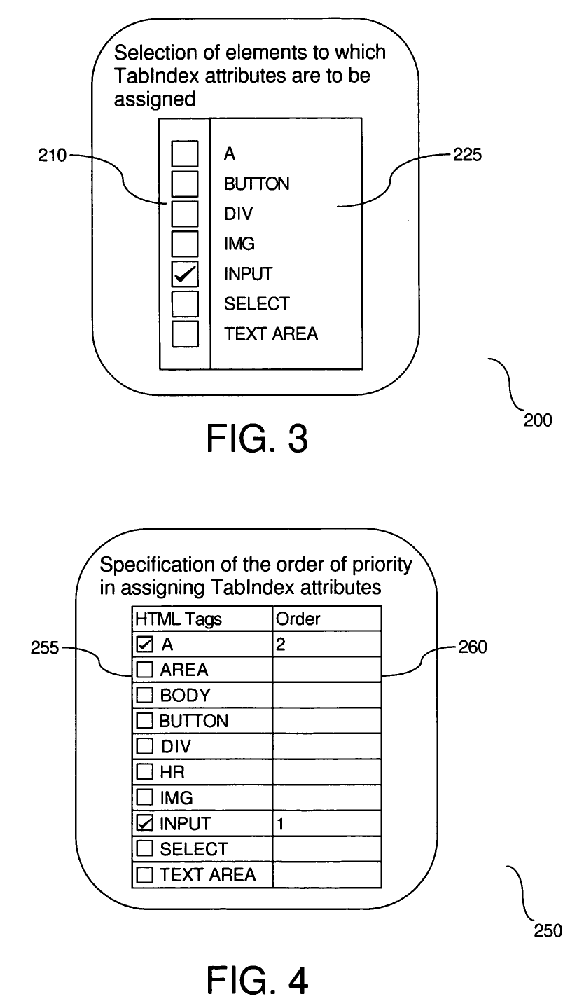

FIG. 3 is a block diagram (200) of an example of a list of elements as they may be presented to the developer in a graphical user interface. The example shown in FIG. 3 should not be considered limiting in the quantity of elements, nor in the presentation format. The list may be enlarged to include additional elements, and may similarly be reduced to include fewer elements. In addition, the list may be presented to the developer in a different format. The list includes a column (210) of individual selection boxes adjacent to a column of selectable elements (225). The developer must mark each box to select a specified element for assignment of TabIndex attributes. FIG. 4 is a block diagram (250) of an example of a list of elements (255) as they may be presented to the developer in a graphical user interface. The example shown in FIG. 4 should not be considered limiting in the quantity of elements, nor in the presentation format. The list may be enlarged to include additional elements, and may similarly be reduced to include fewer elements. In addition, the list may be presented to the developer in a different format. The list includes an order column (260) of individual selection boxes adjacent to a column of selectable elements. The developer must place the list of selected elements in numerical order to specify an order for assignment of TabIndex attributes. In one embodiment, the features of FIGS. 3 and 4 may be combined into a single presentation to the developer with two input columns. A first column would receive indicia to select an element, and a second column would receive indicia in the form of a number to place the selected elements in a hierarchical order. Accordingly, the developer selects from a list of elements provided by the unit for selecting tags to assign TabIndex attributes and places the selected tags in a hierarchical order through the setting order rules specification unit.

Following the assignments by the developer at steps (106) and (108), the developer executes the TabIndex assigning unit which automatically assign TabIndex attributes to the selected tags in the specified order (110). The TabIndex assigning unit, extracts all tags on the HTML formatted page (112), and produces a selection of tags to assign Tablndex attributes (114) according to the list of elements designated at step (106). After the tags have been selected, positional information on the tags as provided by the developer are acquired (116), according to the hierarchical numerical listing provided. The numerical order for setting the tags is extracted (118) from the TabIndex attribute assigning unit (50). Once data pertaining to the designated tags and the order have been acquired, a comparison of the positional information on the tags is conducted (120). When positions for tag elements on a display correspond to the sequence of the description in source code, it is not necessary to embed TabIndex attributes in the order in which HTML sources were analyzed. However, when position on the display does not correspond to the sequence of description of source code, it is necessary to embed TabIndex attributes in a specified order so that the movement by the tab key corresponds to the display. Rules for assigning TabIndex attributes may be flexible to enable the following: priority to be assigned to setting positions along the vertical axis over those along the horizontal axis, priority to be assigned to setting positions along the horizontal axis over those along the vertical axis, and using z-index on the layer containing tags to specify setting positions. Under the rules, giving priority of setting positions along the vertical axis over those along the horizontal axis, the order should be specified to give higher priority to those that are placed higher along the vertical axis, and in the case of HTML elements equally high along the vertical axis, giving higher priority to those that are placed further to the left along the horizontal axis. In one embodiment, the tool may be configured to give higher priority to the direction of the horizontal axis than to the direction of the vertical axis. Following a determination of order for assignment as determined at step (122), the TabIndex attributes are assigned to the selected elements (124). Accordingly, the tool automatically assigns TabIndex attributes to selected elements in a hierarchy provided, and in accordance with positional information provided.

There are cases in formatting of an HTML document that a <div> tag is implemented to extend the alignment attributes of the start of a paragraph block to groups of block elements, such as paragraphs, tables and images. All the block elements within a <div>tag inherit their alignment attributes from the initial <div> tag, unless the elements have their own alignment attributes. Since, the <div> tag sets an absolute position of a field it is necessary to assign the TabIndex attribute in consideration the fact that the sequence of movement of fields and their appearance in the HTML source is not necessarily the same. For example, when an element is newly added to a HTML formatted document with absolute positions of the element specified, TabIndex attributes are assigned to them based on the judgment of their positional relationship with elements within the document for which absolute positions are not specified.

The process of automatically embedding TabIndex attributes in an HTML document is directed at specific tags for which the assignment of TabIndex attributes is desirable. This enables the developer of the document to focus on development aspects without concern for the tedious project of manually embedding TabIndex attributes. In one embodiment, the process of automatically embedding TabIndex attributes may be in the form of an apparatus that includes managers for executing the placement of the TabIndex attributes. For example, the apparatus may include a tag manager to extract selected categories of tags from the document and to assign TabIndex attributes to the extracted tags. The apparatus may also include a position manager to acquire position information for the extracted tags, and to compare the extracted positions to rules for assignment of position information, an attribute assignment manager to determine and assign an order for TabIndex attributes, and a rule manager for extracting and setting assignment rules for TabIndex attributes. In one embodiment, the managers may take the form of a computer program product accessible from a computer-useable or computer-readable medium providing program code for use by or in connection with a computer or any instruction execution system. For the purposes of this description, a computer-useable or computer-readable medium can be any apparatus that can contain, store, communicate, propagate, or transport the program for use by or in connection with the instruction execution system, apparatus, or device.

### Advantages Over the Prior Art

The automatic embedding of TabIndex attributes support enhanced flexibility in creating HTML formatted documents. The tool enables a developer to select specifically defined tags for the automatic assignment. In addition, the developer may select an order for assignment based upon a numeric ordering, position within the document, and/or characteristics of the tags. The method and apparatus removes the time consuming aspect of manually assigning TabIndex attributes from the developer at the time of programming the document, and enables the developer to focus on more sensitive issues associated with development of an HTML formatted document. Rules may be invoked to specify assignment of TabIndex attributes with respect to sequence of movement and appearance of fields, as well as to prioritize assignment of identified elements. Accordingly, the method and apparatus enables a developer to specify parameters for automatic embedding of TabIndex attributes.

### Alternative Embodiments

It will be appreciated that, although specific embodiments of the invention have been described herein for purposes of illustration, various modifications may be made without departing from the spirit and scope of the invention. In particular, the invention should not be limited to a developer invoking the method and/or apparatus. Rather, the tool may be invoked by any individual. Similarly, the method and apparatus may be invoked through a graphical user interface, or any other interface which supports the developer specifying rules for placement of TabIndex attributes. Accordingly, the scope of protection of this invention is limited only by the following claims and their equivalents.

We claim:

1. A method for formatting HTML content comprising:
specifying rules for adding TabIndex attributes to a tag in a HTML formatted document; and
automatically adding said TabIndex attributes into said document responsive to said rules.

2. The method of claim 1, wherein the step of specifying rules for adding index attributes includes assigning said TabIndex attributes with respect to sequence of movement of fields and appearance of said fields.

3. The method of claim 1, wherein the step of specifying rules for adding TabIndex attributes includes identifying elements to which attributes are to be assigned.

4. The method of claim 3, further comprising prioritizing assignment of said identified elements.

5. The method of claim 1, wherein said rules are selected from a group consisting of:
giving priority to setting positions along a vertical axis over those along a horizontal axis, giving priority to setting positions along a horizontal axis over those along a vertical axis, specifying setting positions by using z-index on a layer containing tags, and combinations thereof.

6. The method of claim 1, wherein the step of specifying rules for adding TabIndex attributes to a tag includes a tag selected from a group consisting of: a, button, div, img, input, select, textarea, and combinations thereof.

7. The method of claim 1, wherein the step of specifying rules for adding TabIndex attributes to a tag includes defining a kind of tag for assignment of said attribute and assigning an order for adding said TabIndex attribute to said tag.

8. A HTML formatting tool comprising:
a rule manager adapted to direct a set of rules to specify addition of TabIndex attributes to a tag in a HTML formatted document; and
a TabIndex manager adapted to automatically add said TabIndex attributes into said document in response to said rules.

9. The tool of claim 8, wherein said rule manager assigns said TabIndex attributes with respect to sequence of movement and appearance of fields.

10. The tool of claim 8, wherein said rule manager identifies elements to which attributes are to be assigned.

11. The tool of claim 10, further comprising assignment of a priority to said identified elements.

12. The tool of claim 8, wherein said rules are selected from a group consisting of:
giving priority to setting positions along a vertical axis over those along a horizontal axis, giving priority to setting positions along a horizontal axis over those along a vertical axis, specifying setting positions by using z-index on a layer containing tags, and combinations thereof.

13. The tool of claim 8, wherein said tag is selected from a group consisting of: a, button, div, img, input, select, textarea, and combinations thereof.

14. The tool of claim 8, wherein said rule manager defines a kind of tag for assignment of said attribute and an order for addition of said TabIndex attribute to said tag.

15. A computer program product comprising:
a computer useable medium embodying computer usable program code for formatting HTML content, said computer program product including:
computer useable program code for specifying rules for adding TabIndex attributes to a tag in a HTML formatted document; and
computer useable program code for automatically adding said TabIndex attributes into said document responsive to said rules.

16. The computer program product of claim 15, wherein said code for specifying rules for adding TabIndex attributes to a tag includes assigning said TabIndex attributes with respect to sequence of movement of fields and appearance of said fields.

17. The computer program product of claim 15, wherein said code for specifying rules for adding TabIndex attributes to a tag includes identifying elements to which attributes are to be assigned.

18. The computer program product of claim 17, further comprising computer useable program code for prioritizing assignment of said identified elements.

19. The computer program product of claim 15, wherein said code for specifying rules for adding TabIndex attributes to a tag includes a tag selected from a group consisting of: a, button, div, img, input, select, textarea, and combinations thereof.

20. The computer program product of claim 15, wherein said code for specifying rules for adding TabIndex attributes to a tag includes defining a kind of tag for assignment of said attributes and assigning an order for adding said TabIndex attribute to said tag.
